(19) United States
(12) Patent Application Publication
(10) Pub. No.: US 2016/0350005 A1
(43) Pub. Date: Dec. 1, 2016

(54) DATA RECORDING AND REPRODUCING SYSTEM

(71) Applicant: Panasonic Intellectual Property Management Co., Ltd., Osaka (JP)

(72) Inventors: Akinori YUBA, Osaka (JP); Makoto USUI, Osaka (JP); Kazutaka MORITA, Kanagawa (JP)

(21) Appl. No.: 15/163,071

(22) Filed: May 24, 2016

(30) Foreign Application Priority Data
May 25, 2015 (JP) 2015-105602

(51) Int. Cl. G06F 3/06

(52) U.S. Cl. CPC G06F 3/0607; G06F 3/0635; G06F 3/0658; G06F 3/0686

(57) ABSTRACT

A data recording and reproducing system of the present disclosure includes a storage device that stores data, and a data management device that controls recording and reproducing of data in and from the storage device. The data management device includes a first storage, a database that manages information representing a recording region in the storage device for an object, and a controller that controls the storage device according to requests to record and reproduce data When accepting the request to record data, the controller refers to the database so as to store the data of the object in the storage device. Further, the controller stores first management information in the first storage in first management information, information, for specifying an object and index information representing a region in the storage device where the object is stored are related to each other.

### BACKGROUND

### 1. Technical Field

The present disclosure relates to a data recording and reproducing system that is capable of recording an object in a recording medium.

### 2. Description of Related Art

Conventionally, demand for a data archive system has been increased. Such a data archive system serves as one large-capacity storage formed by a plurality of bard disks, and treats file-based data. Such a data archive system includes a client terminal and a storage device that is connected to the client terminal via a network. The storage device is a single-function server configured so that a hard disk, a network interface, an OS (an Operating System), and a management utility are integrated.

As a conventional data archive system, for example, a system disclosed in Unexamined Japanese Patent Publication No. 2011-159242 is known. Unexamined Japanese Patent Publication No. 2011-159242 discloses an archive storage device that additionally stores data in a plurality of tile systems of a disc array device.

In Unexamined Japanese Patent Publication No. 2011-159242, the disc array device is configured to correspond to the file system. A semiconductor memory element or a hard disk is assumed as the disc array device. In this document, rearrangement of data is premised in order to avoid useless free space from being left in the file system.

Further, according to Swift of an Open Stack Object Storage that realizes a distributed data storage in a cloud environment, a recording destination of an object is decided by Ring information. This Ring information decides the recording destination of an object according to a predetermined rule based on a hash value calculated from an object name including a pathname.

### SUMMARY

A first aspect of the present disclosure provides a data recording and reproducing system. The data recording and reproducing system includes a storage device and a data management device. The storage device has a recording medium that stores data. The data management device controls recording of data in the storage device and reproducing of data from the storage device.

The data management device includes an acceptor, a first storage, a second storage, and a controller. The acceptor specifies an object name including a pathname, and accepts a request to record or reproduce an object in or from the storage device. The first storage stores predetermined management information. The second storage stores a database that manages information representing a recording region on the storage device for an object. The controller controls the storage device according to the request.

When the acceptor accepts the request for recording of an object, the controller refers to the database and specifies a recording region on the storage device for the object, and stores data of the object in the specified region. Further, the controller stores first management information in the first storage. In the first management information, information for uniquely specifying an object is related to index information representing a region in the storage device that stores the object.

### BRIEF DESCRIPTION OF DRAWINGS

FIG. 1 is a schematic configuration diagram of a data archive system according to a first exemplary embodiment;

FIG. 2 is it diagram illustrating an internal configuration of is data management server;

FIG. 3A is a diagram illustrating as configuration of a storage device;

FIG. 3B is a perspective view illustrating a schematic configuration of a data unit;

FIG. 3C is as diagram describing a magazine to be stored in the data unit and a plurality of optical discs to be stored in the magazine;

FIG. 4 is a diagram describing a correspondence relationship between account/containers/objects and the magazines;

FIG. 5 is a diagram illustrating a configuration example of a magazine group list;

FIG. 6 is a diagram illustrating a configuration example of object/magazine group ID correspondence information;

FIG. 7 is a diagram illustrating a configuration example of magazine information;

FIG. 8 is a flowchart illustrating a process for recording (writing) an object;

FIG. 9 is a diagram describing regions which are determined based on hash values and where magazine group IDs are recorded;

FIG. 10 is a flowchart illustrating a process for reproducing (reading) an object; and

FIG. 11 is a diagram illustrating another configuration example of the data archive system.

### DETAILED DESCRIPTION

Exemplary embodiments are described in detail below with reference to the drawings. Description that is detailed beyond necessity is occasionally omitted. For example, detailed description about already well-known matters and overlapped description about substantially same constitutions are omitted in some cases. The omission is carried out in order to avoid redundancy of the following description and to make a person skilled in the art easily understand the present disclosure.

The inventor(s) provide the accompanying drawings and the following description in order that a person skilled in the art can fully understand the present disclosure, and thus do not intend to limit the subject matters described in claims due to these drawings and description.

Background Led to the Present Disclosure

In a conventional archive system, as described in Unexamined Japanese Patent Publication No. 2011-159242, a semiconductor memory element or a hard disk is used. In this case, an archived data storage life is determined by a life of a semiconductor memory element or a life of a hard disk. The data storage life in the semiconductor memory element called a flash memory is generally about 10 years.

Further, in general, a hard disk is often replaced by a new type of a large capacity hard disk every three through five years depending on a usage environment of the hard disk. In this case, data should be transferred from an old hard disk to a new hard disk, and this transfer operation is called migration. According to recent diffusion of IT, data to be saved as an archive has been steadily increased, and a demand to avoid the complicated migration operation that needs a long time as much as possible has been increased.

To meet the above demand, in recent years, an attention has been paid to an optical disc. An optical disc is a data saving medium with high reliability that has a solid track record over a long period of history. For example, it is reported that a data saving life of 50 or more years is realized in a write-once type Blu-ray Disc for archive.

Since storage of media does not need energization and thus does not generate a heat, migration is not necessary. The media are suitable for long-period storage at a low cost. However, a WORM (Write Once Read Many) type disc is the in of such an optical disc for long-period storage, and this disc has a constraint that rewriting cannot be performed freely. Therefore, the WORM type disc cannot be treated equivalently to a hard disk from an aspect of usability.

Further, in order to heighten dust resistance and facilitate the treatment of an optical disc, a few dozen discs are occasionally stored in each cartridge that is called a magazine. However, since data recording and reproducing are performed for each magazine in this case, correspondence between data and each magazine should be invented prior to the data recording and reproducing.

Further, each magazine can be taken out of a drive device and can be stored on a shelf, but file names of recorded data cannot be obtained until each magazine is inserted into the drive device and reproduction is performed.

Further, archive data is generally added over time and the number of magazines increases, but it is difficult to freely expand a system in a conventional archive device.

The inventors of this applicant have invented a data archive system described below in consideration of such a background.

### First Exemplary Embodiment

A first exemplary embodiment is described below with reference to the accompanying drawings.

1-1. Constitution

1-1-1. Entire Constitution

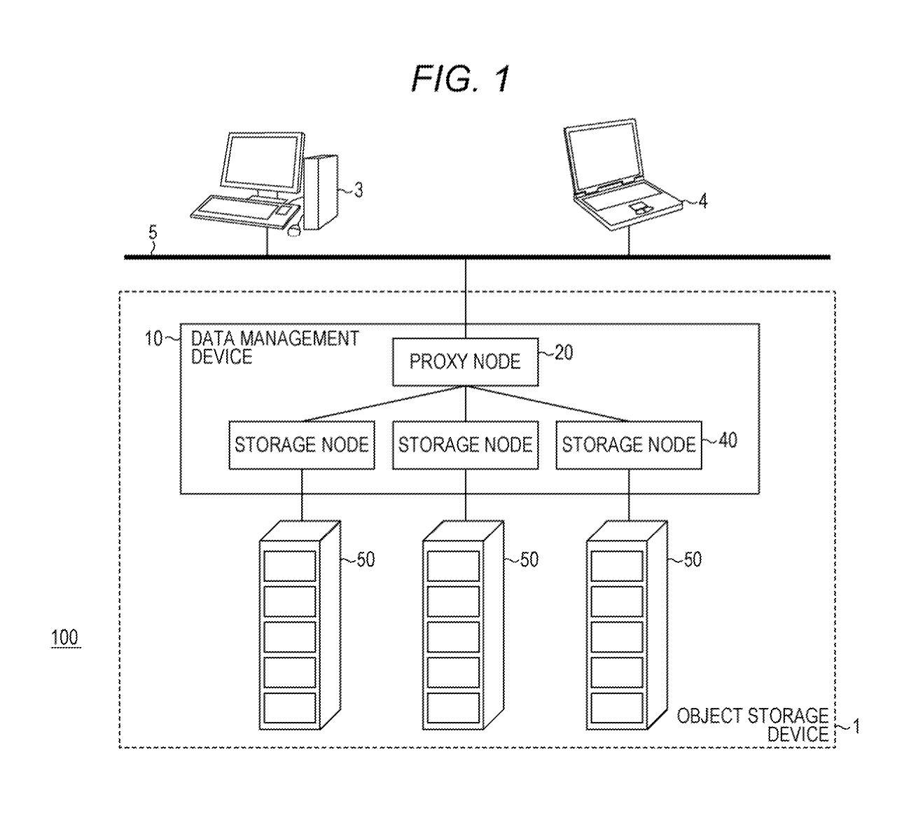

A data archive system (one example of a data recording and reproducing device) according to the exemplary embodiment of the present disclosure is described. FIG. 1 is a schematic configuration diagram of the data archive system according to this exemplary embodiment.

In FIG. 1 data archive system 100 according to this exemplary embodiment includes object storage device 1, browsing terminal (hereinafter, “client terminal”) 3, and management terminal 4.

Client terminal 3 is a computer that uses a function and data provided by object storage device 1 according to a user's operation. Client terminal 3, object storage device 1, and management terminal 4 are connected to each other via network 5.

Object storage device 1 includes data management device 10 and storage devices 50. Details of respective component forming object storage device 1 are described below.

1-1-2. Data Management Device

Data management device 10 is formed by proxy node 20 and storage 20 nodes 40. Proxy node 20 is a server device that has a function for distributing and arranging data (objects) in each storage device. Storage nodes 40 are server devices each of which has a function for controlling recording and reproducing the data (the objects) in and from storage devices 50, respectively. These devices can be formed by an information processing device.

1-1-3. Proxy Node

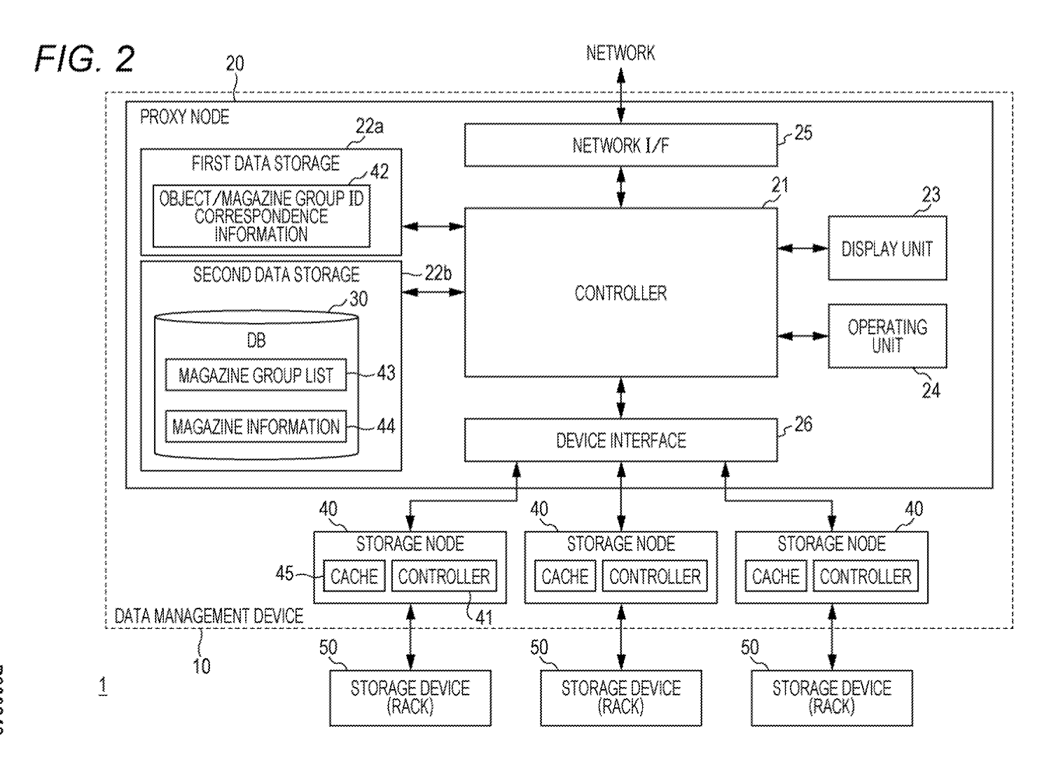

FIG. 2 is a diagram illustrating an internal configuration of proxy node 20. Proxy node 20 includes controller 21, first and second data storages 22a, 22b, display unit 23, and operating unit 24. Controller 21 controls an entire operation of proxy node 20. First and second data storages 22a, 22b store data and programs. Display unit 23 displays predetermined information. Operating unit 24 accepts instructing and setting operations from a user.

Display unit 23 is formed by, for example, a liquid crystal display, an organic EL (Electroluminescent) display, an LED (Light Emitting Diode) element or the like. Operating unit 21 includes a keyboard, a mouse, a button, and a touch panel.

Further, proxy node 20 has a network interface unit 25 (one example of an acceptor) that connects to a network such as LAN (a Local Area Network). Network interface unit 25 makes communication based on, for example, standards such as IEEE802.

Further, proxy node 20 includes device, interface unit 26 that connects external devices. Device interface unit 26 is an interface for connecting storage devices 50 to data management device 10, and makes communication based on predetermined communication standards such as SAS (Serial Attached SCSI).

Controller 21 controls the entire operation of proxy node 20, namely, a function. Controller 21 is formed by a CPU (a Central Processing Unit) or MPU (a microprocessor) that executes a control program so as to realize a predetermined function. A program to be executed by controller 21 may be provided via a communication line or a recording medium such as a CD, a DVD, or a memory card. Controller 21 may be formed by a dedicated hardware circuit (ASIC (an Application Specific integrated. Circuit), FPGA (a Field Programmable Gate Array) or the like) that is designed to realize a predetermined, function.

First and second data storages 22a, 22b are devices that store control programs, management information necessary for the control, or the like. In this exemplary embodiment, first and second data storages 22a, 22b are formed by hard disks (HDDs). First and second data storages 22a, 22b may be formed by SSDs (Solid Sate Drives), semiconductor memory elements, optical discs or the like instead of the hard disks. First data storage 22a stores object/magazine group ID correspondence information 42 as the management information. Second data storage 22b stores database 30 including magazine group list 43 and magazine information 44 as the management information. Details of the management information are described later.

1-1-4. Storage Node and Storage Device

Each storage node 40 has a configuration similar to the configuration of proxy node 20, and controls the recording and the reproducing of data (object) in and from each storage device 50. Each storage node 40 includes controller 41 that controls the function of each storage node 40.

Each controller 41 is formed by a CPU or an MPU that executes a control program so as to realize a predetermined function. Alternatively, each controller 41 may be formed by a specific hardware circuit (an ASI), an FPGA, etc.) that is designed to realize the predetermined function.

Each storage node 40 further includes cache 45 that temporarily retains data to be recorded or reproduced in or from each storage device 50. Each cache 45 is formed by a hard disk, an SSD, a semiconductor memory or the like.

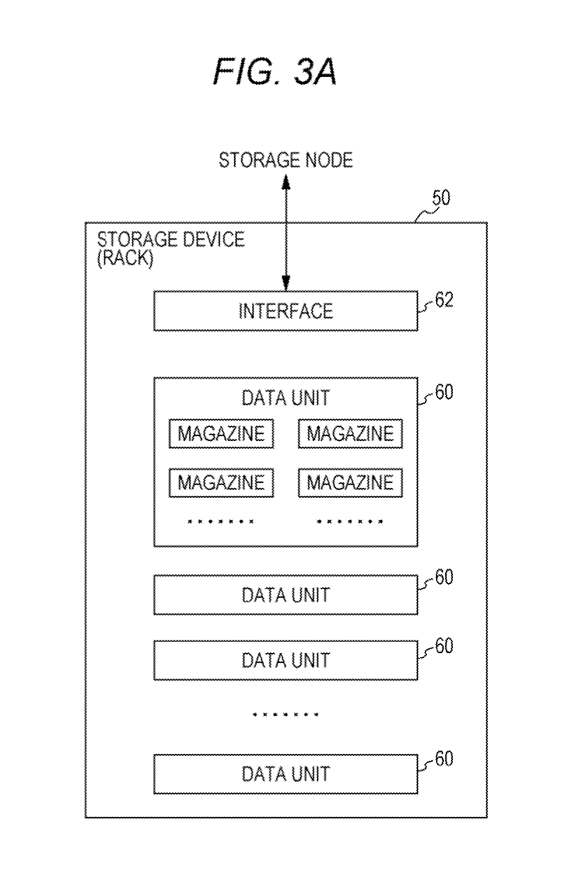

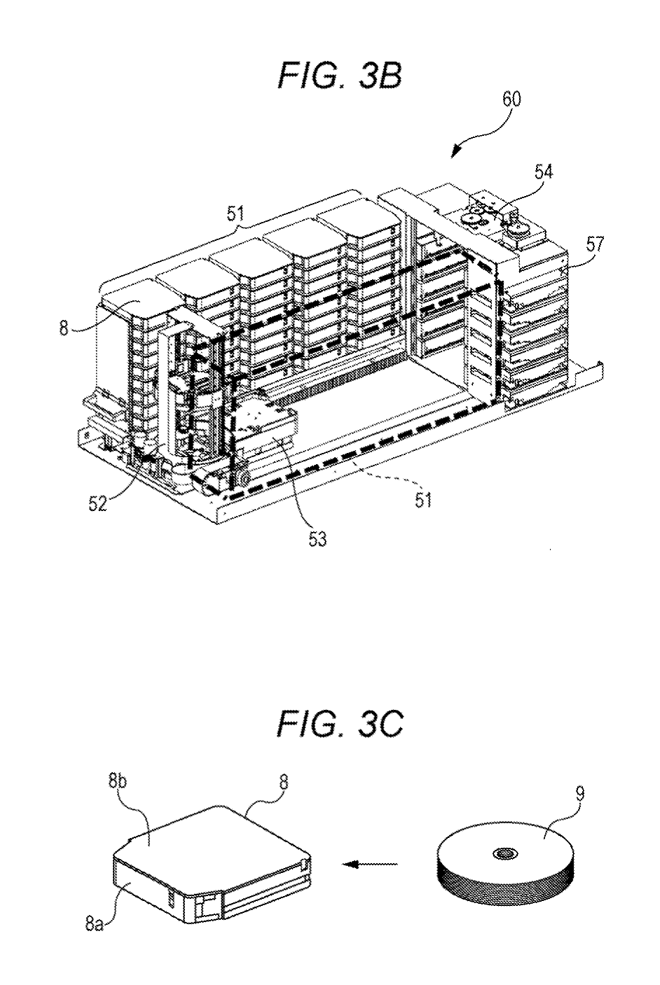

Each storage device 50 is an information recording device with large capacitance having a plurality of optical discs (media) as recording media. FIG. 3A is a diagram illustrating an internal configuration of storage device 50. Storage device 50 includes a plurality of data units 60 that record data, and interface 62 that performs data communicates with a storage node.

FIG. 3B is a perspective view illustrating a schematic configuration of one data unit 60. FIG. 3C is a diagram describing magazine 8 to be stored in the data unit 60 and a plurality of optical discs 9 to be stored in magazine 8.

Data unit 60 includes two magazine stockers 51 that are examples of storage portions that store magazines 8. For convenience of the description, magazine stocker 51 on one side (a front side) is omitted in FIG. 3B. Two magazine stockers 51 are disposed so as to be opposed to each other. Further, top boards and partition hoards of magazine stockers 51 are also omitted in FIG. 3B.

Each magazine stocker 51 houses the plurality of magazines 8. In this exemplary embodiment, each magazine stocker 51 houses 45 magazines 8. Each magazine 8 includes magazine tray 8a that houses a plurality of optical discs 9, and case 8b that houses magazine tray 8a as shown in FIG. 3C.

In this exemplary embodiment, a 100 GB (gigabyte) BD-R (Blu-ray (registered tradename) Disc Recordable that is a write-once type recording medium is used as optical discs 9. Magazine tray 8a houses twelve 100 GB (gigabyte) BD-Rs, and thus storage capacity in one magazine 8 is 1.2 TB (terabytes). Entire storage capacity in one data unit 60 is 108 TB(=1.2 TB×45×2).

Further, in this exemplary embodiment, each magazine 8 is provided with a RFID (radio frequency ID) to (not shown). Each RFID tag has a unique identification number.

Picker 52 is provided between two magazine stockers 51. Picker 52 pulls magazine tray 8a out of one magazine 8 selected, from a plurality of magazines 8 so as to hold the magazine tray 8a. Picker 52 carries held magazine tray 8a to a vicinity of a plurality of drives 57 disposed cm a rear side of the device. Picker 52 is provided with lifter 53 integrally. Lifter 53 pushes a plurality of optical discs 9 out of magazine tray 8a.

Each drive 57 records (writes) and reproduces (reads) a file (an object) in and from optical disc 9. In this exemplary embodiment, each drive 57 is a tray-type drive that loads optical disc 9 using the tray. Each drive 57 may be a device that records and reproduces a file in and from optical disc 9.

A plurality of drives 57 is disposed so as to be stacked in a height direction of the device (data unit 60) and to be adjacent to each of magazine stockers 51 on the rear side of the device. Carrier 54 is disposed between a plurality of drives 37 stacked adjacently to one of magazine stockers 51 and a plurality of drives 57 stacked adjacently to the other one of magazine stockers 51.

Carrier 54 holds a plurality of optical discs 9 pushed out by lifter 53, and separates one disc from a plurality of held optical discs 9 above the tray (not shown) discharged from any drive 57 so as to place the separated disc on the tray.

An electric circuit and a power supply (not shown) are provided, on the rear side farther than carrier 54 and a plurality of drives 57. The electric circuit and the power supply are provided with a controller (not shown) that controls operations of the respective devices (a motor, etc.) such as picker 52, drives 57, and carrier 54.

Storage device 50 is configured so that a plurality of data units 60 shown in FIG. 3B is stacked so as to be housed in storage device 50. Storage device 50 includes a cache that temporarily holds access data at a time of a data access to each magazine 8. Further, the controller of one data unit 60 to be housed in storage device 50 communicates with storage node 40, and controls the operation for recording an object in magazine 8 and the operation for reproducing an object from magazine 8 according to a request from storage node 40.

1-1-5. API of Swift

Object storage device I in this exemplary embodiment is configured so as to enable an operation using an API of Swift that is an Open Stack Object Storage.

That is to say, object storage device 1 has a function for accepting a request (a command) of “PUT” (creation and updating of an object, etc.) or “GET” (obtaining of an object, etc.) in Swift and providing a processed result similar to a case of Swift.

The configuration of object storage device 1 in this exemplary embodiment can be applied, also to a configuration that employs REST (Representational State Transfer) API other than Swift.

In Swift, data is managed in a hierarchy structure of account/container/object. A user is to be authorized according to an account. The account can have a plurality of containers. The container is similar to a directory of a file system as a concept, but the container cannot have another container. The container can store a plurality of objects. One or more pieces of any data having a Key=Value format can be given to the account, the container, and the object, respectively.

According to Swift, arrangement information that represents a saving correlation among data, nodes, and directories can be uniquely calculated based on data “Ring” shared in the entire system. Ring defines a rule for determining a recording position of an object based on a hash value calculated from names of the account/container/object. Due to this Ring function, Swift does not have to exercise centralized management on the arrangement information of data, and thus scaling-out becomes easy.

However, data archive system 100 according to this exemplary embodiment should perform data recording and reproducing on magazine 8 formed by write-once type optical discs. That is to say, a storage destination of a file main body is restricted to magazine 8 having a free space.

For this reason, storage destinations of data (an object) in storage device 50 cannot he determined according to the Ring that randomly determines a recording destination simply based on a hash value. Therefore, the inventors of this application have invented a new method, for indirectly relating data, namely, objects to magazines where the objects are recorded.

That is to say, a correlation relationship between data (objects) and magazines 8 is managed by object/magazine group ID correspondence information 42, magazine group list 43, and magazine information 44. Object/magazine group ID correspondence information 42 is for relating objects and magazine group IDs. Magazine group list 43 and magazine information 44 are for relating the magazine group IDs, the magazines, and the racks. The storage destinations of data (objects) in storage devices 50 are determined by magazine group list 43 and magazine information 44 stored in database 30 (details are described later).

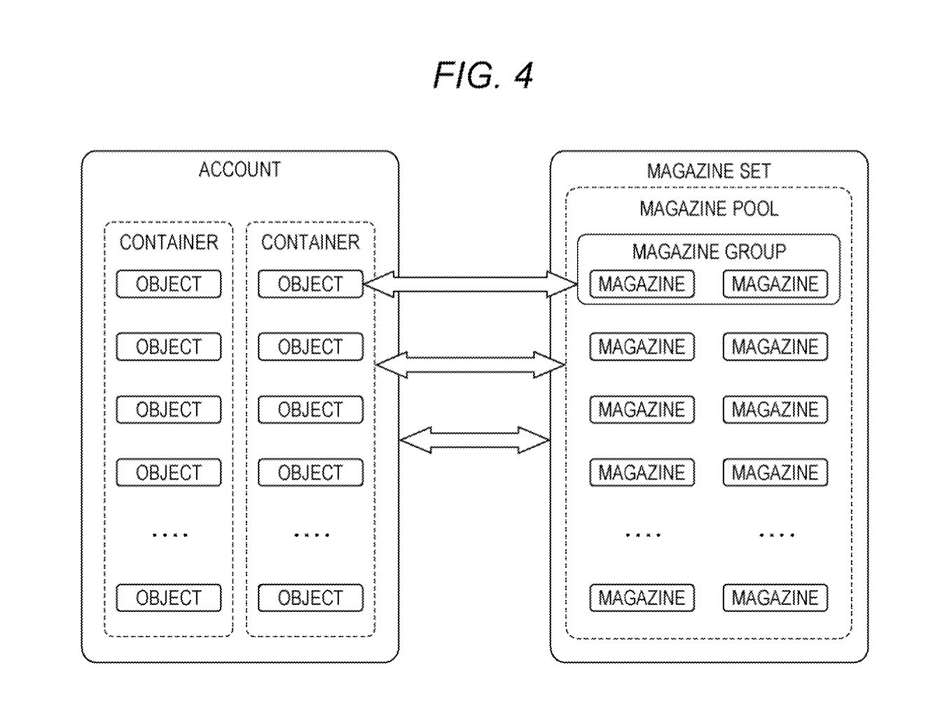

FIG. 4 is a diagram describing a correspondence relationship between accounts, containers, objects, and magazines in Swift. Users are authorized according to accounts, and a set of magazines allocated according to the accounts. This is called “a magazine set”. Each account can define a plurality of sets of recording files called containers, and the magazines are allocated to the containers, respectively.

A set of magazines allocated from the magazine set by container unit is called “a magazine pool”. Each container can hold an object. “A magazine group” in the magazine pool is allocated to an object. The magazine group is formed by magazines whose number is equal to multiplexing (duplication) of an object.

The magazine group may store only one object but may also store a plurality of objects at the same time. A magazine set includes a free magazine that is not yet allocated to a magazine pool. A magazine to be multiplexed, can be distributed to different storage devices 50, and in this case redundancy can be secured also for a mechanism failure of specific storage device 50.

1-1-6. Management Information

Management information to be used in object storage device 1 according to this exemplary embodiment is described. As shown in FIG. 2, object storage device 1 has object/magazine group ID correspondence information 42, magazine group list 43, and magazine information 44 as management information. Magazine group list 43 and magazine information 44 are managed in database 30.

(1) Magazine Group List

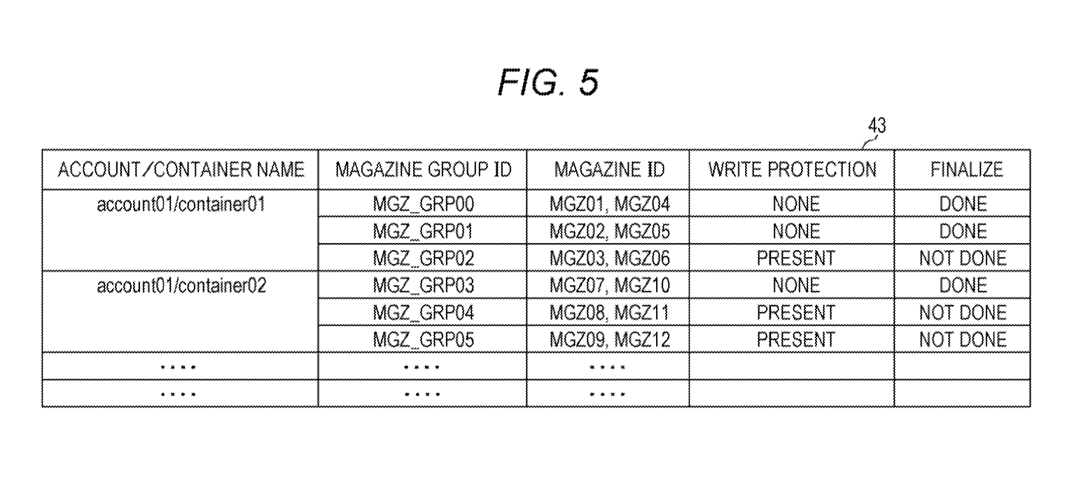

FIG. 5 illustrates a configuration example of magazine group list 43. In magazine group list 43, correspondence between magazine group IDs and IDs of magazines included in corresponding magazine groups. This correspondence is managed in container unit.

In this exemplary embodiment, an object is saved in two magazines and is duplicated. An ID of a magazine group including those two magazines and the object form correspondence information in Swift. In Swift, a magazine group ID taken out from magazine group list 43 according to round robin is related to an object when the object is recorded, and an index is added to object/magazine group ID correspondence information 42.

Magazine group list 43 further includes information about a state of write protection and a state of finalizing. Magazine group list 43 is stored in database 30 in advance. Magazine group list 43 is set by a system administrator. In magazine group list 43, a list that is related to magazine IDs of magazines 8 mounted to storage devices (racks) 50 and takes duplication recording into consideration is set. When a storage structure is changed due to addition, replacement and removal of magazine 8 and storage device 56, the system administrator changes the setting of magazine group list 43.

(2) Object/Magazine Group ID Correspondence Information

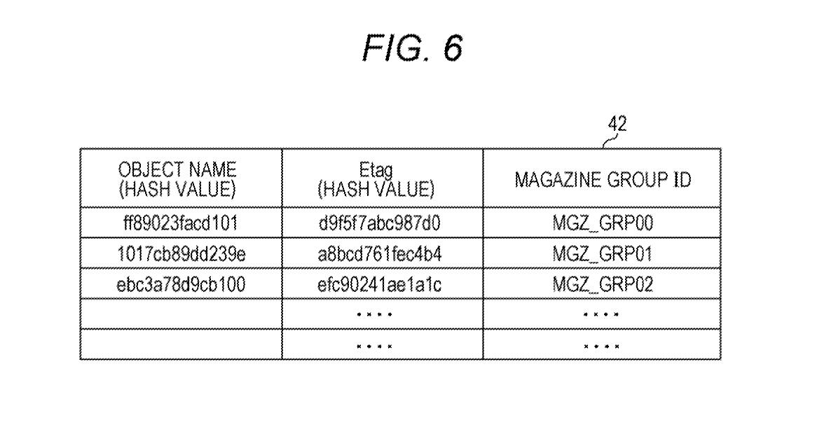

FIG. 6 illustrates a configuration example of object/magazine group ID correspondence information 42. Object/magazine group ID correspondence information 42 is correspondence information about magazine group IDs managed in above-mentioned magazine group list 43 and objects (object names (hash values), Etag values). Those values (Etags and magazine group IDs) can be obtained by specifying object names.

Each object name is specified by each hash value calculated based on each object name including each pathname (account/container/object). Each Etag is a hash value that is calculated based on data contents of each object, and a value that is obtained uniquely for an object. Each magazine group ID is for identifying each magazine group. Object/magazine group ID correspondence information 42 is recorded in first data storage 22a of data management device 10.

Object/magazine group ID correspondence information 42 is updated by controller 21 of proxy node 20, in object/magazine group ID correspondence information 42, each object and each magazine ID are not related in order to avoid necessity of individual changes in relation with an object when a magazine cannot be used and replacement should be carried out.

(3) Magazine Information

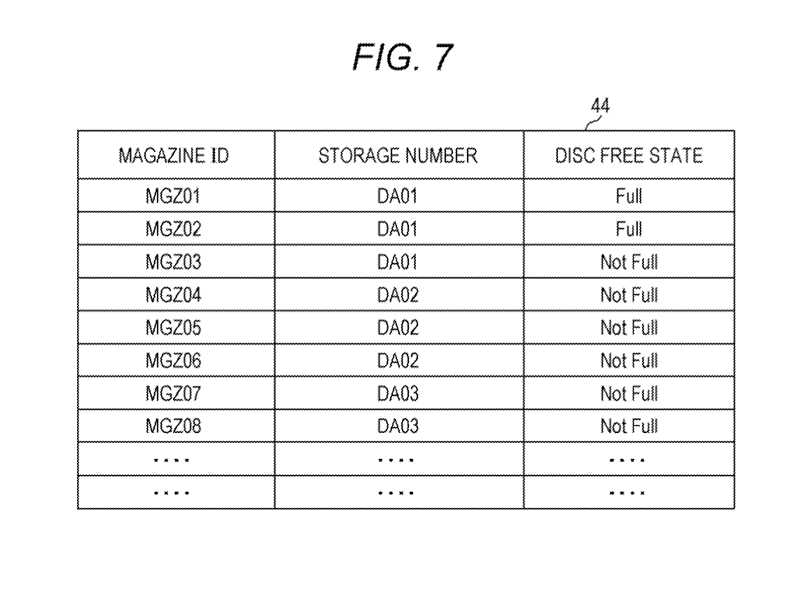

FIG. 7 illustrates a configuration example of magazine information 44. Magazine information 44 stores a list of magazines in storage device (rack) 50, states and free spaces of the respective magazines. Specifically, in magazine information 44, magazine IDs, numbers representing storage devices 50 related to the magazines (hereinafter, “storage numbers”), and free states of the magazines are related to each other so as to be managed.

Further, an expire date is set in magazine information 44, and a magazine included in magazine information whose expire date has passed is regarded as being off line. Magazine information 44 is stored in database 30. Magazine information 44 is set by the system administrator.

When a storage structure is changed due to addition, replacement and removal of a magazine, the system administrator changes the setting of magazine information 44. Alternatively, magazine group list 43 and magazine information 44 to be stored in database 30 can be configured so as to be automatically updated by notification from storage node 40.

1-2. Operation

Operations for recording and reproducing an object in data archive system 100 having such a configuration are described below.

1-2-1. Recording Operation

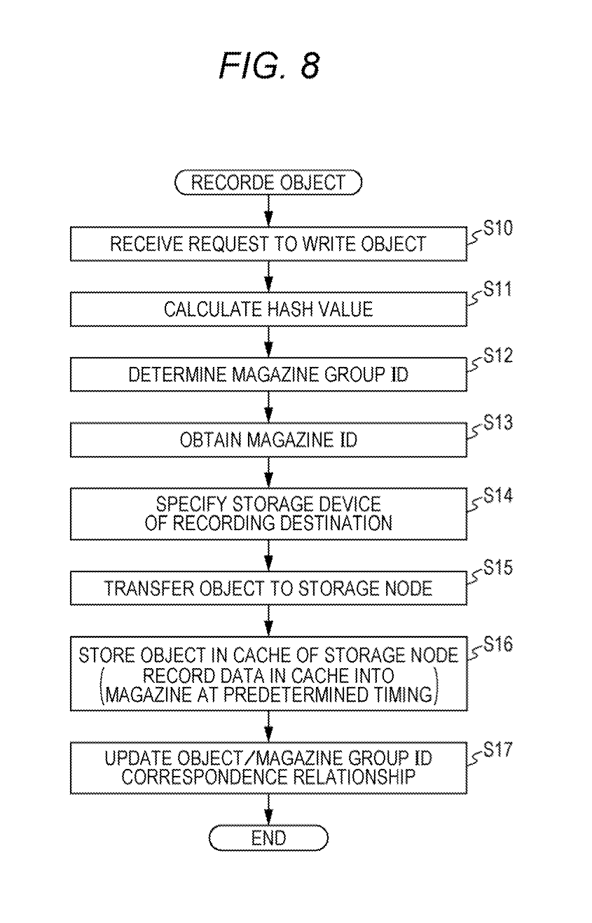

FIG. 8 is a flowchart illustrating a process in data archive system 100 when an object is recorded in storage device 50. This process is executed mainly in controllers 21, 41 of proxy node 20 and storage node 40 in data management device 10.

A user operates client terminal 3, and specifies names of account/container/object so as to request recording of the object in object storage device 1. When controller 21 of proxy node 20 in object storage device 1 receives the request from the user (S10), controller 21 calculates as hash value (one example of a value uniquely representing the names of account/container/object) based on the names of account/container/object (S11).

For example, when “account01/container01/object01.data” is specified as the names of the account/container/object, and recording and reading an object are requested, a hash value is calculated based on is character string “account01/container01/object01.data”.

Thereafter, controller 21 of proxy node 20 refers to magazine group list 43 stored in database 30, and determines a magazine group ID related to the names of the account/container as a magazine group ID representing a magazine group to which the magazines in which the object is to be recorded belong (S12).

When a plurality of magazine group IDs related to the names of accounts/containers is present, proxy node 20 selects one magazine group ID from a plurality of the IDs sequentially (namely, in a round robin system).

For example, when “account01/container01” is specified as the names of the account/container, magazine group list 43 shown in FIG. 5 is referred to, one magazine group ID is selected sequentially from three magazine group IDs “MGZ_GRP00” “MGZ_GRP01”, and “MGZ_GRP02”.

Further, controller 21 refers to magazine group list 43, and obtains all magazine IDs related to determined magazine group ID (S13). For example, in magazine group list 43 shown in FIG. 5, when MGZ_GRP00 is selected as a magazine group ID, MGZ01 and MGZ04 are obtained.

Controller 21, then, refers to magazine information 44 stored in database 30, and specifies a storage device (rack) where an object should be recorded (S14). Specifically, a storage number of the storage device related to the magazine ID obtained with reference to magazine information 44 is obtained. For example, according to magazine information 44 shown in FIG. 7, “DA01” and “DA02” are obtained as storage numbers for magazine IDs “MGZ01” and “MGZ04”.

Controller 21 specifies magazine IDs and transmits an object to storage node 40 related to all specified storage devices (S15).

Controller 21 refers to magazine information 44 before transmission of the request, and checks a free space of each magazine where an object is to be recorded. When the free spaces of all the magazines where an object is to be recorded indicates a predetermined value or less, namely, when enough free spaces do not, remain, controller 21 notifies the user of an error.

Controller 41 of storage, node 40 stores (accumulates) the received objects in cache 45 (516). When a predetermined time comes, controller 41 of storage node 40 records data accumulated in cache 45 collectively in specified magazines 8 of storage device 50.

When a plurality of storage numbers is obtained in step S14, the object is transmitted to related caches 45 of storage nodes 40, and the data of the objects are recorded in parallel in a plurality of storage devices 50 (multiplication). For example, when storage numbers “DA01” and “DA02” are obtained, the object are recorded in magazines “MGZ01” and “MGZ04”.

Controller 41 of storage node 40 calculates an Etag (a hash value) of the object saved in cache 45 and transmits the Etag to proxy node 20. When the recording of the object in storage device 50 fails, controller 41 of storage node 40 transmits an error to proxy node 20, and at that time proxy node 20 notifies the user of the error via display unit 23.

Controller 21 of proxy node 20 relates a magazine group ID obtained in step 512, an object name (a hash value), and an Etag received from storage node 40 to each other, and records them as object/magazine group ID correspondence information 42 in first data storage 22a (S17).

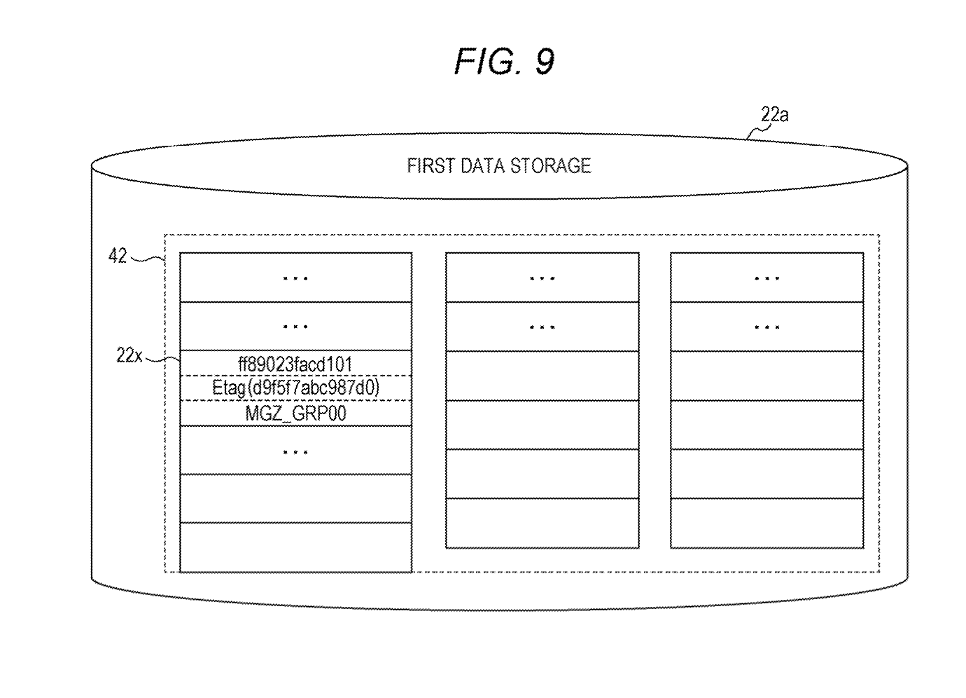

For example, as shown in FIG. 9, controller 21 relates the magazine group ID obtained in step S12 to the Etag received from storage node 40 and records them in region 22x in object/magazine group ID correspondence information 42 stored in first data storage 22a.

According to the Swift function, Ring determines a region (hard disk) where entity data of the object is to be recorded based on the names of account/container/object.

On the contrary, in this exemplary embodiment, such a region is managed by object/magazine group ID correspondence information 42 in which each magazine group ID (namely, index information representing each recording region of an object) is related to each Etag for uniquely specifying an object).

In the above manner, an object is recorded in storage device 50 according to a request to record the object from the user.

Further, when object data is recorded in storage device 50, storage node 40 stores the object data to be recorded in cache 45. Storage node 40 then issues a recording command to storage device 50 at predetermined timing (for example, once a day), and records the cached object data in optical discs 9 in each magazine 8.

When object data is one cached and the object data in each magazine 8 is recorded collectively, frequency of operations for loading and moving optical discs 9 in one magazine 8 can be reduced, and a time entirely required for the recording operation can be shortened.

1-2-2. Reproducing (Reading) Operation

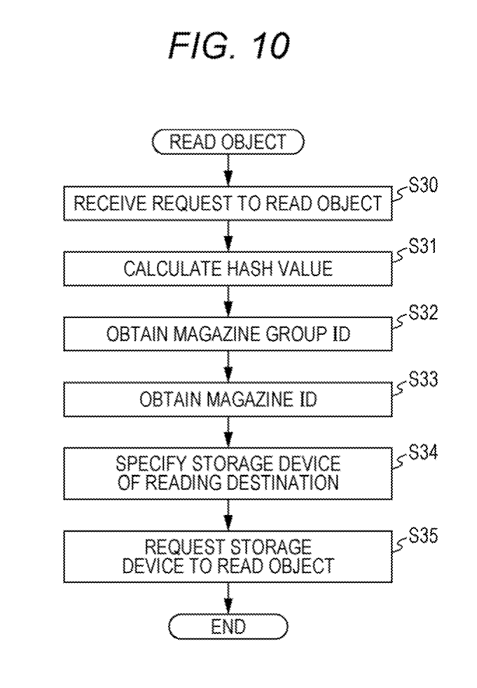

FIG. 10 is a flowchart illustrating, a process in data archive system 100 when an object is reproduced (read) from storage device 50. This process is executed mainly by controller 21, 41 of proxy node 20 and storage node 40 in data management device 10.

The user operates client terminal 3, and specifies the names of account/container/object so as to request to read an object from object storage device 1. When controller 21 of proxy node 20 in object storage device 1 receives the request from the user (S30), controller 21 calculates a hash value from the names of account/container/object (S1).

For example, when “account01/container01/object01.data” is specified as the names of account/container/object and the reading of an object is requested, a hash value is calculated based on a character string “account01/container01/object01.data”.

Controller 21 then refers to object/magazine group ID correspondence information 42, and obtains a magazine group ID and an Etag based on the calculated hash value (namely, the object name) (S32). For example, in the example shown in FIG. 9, “MGZ_GRP00” and an Etag (“d9f5f7abc987d0”) are obtained as a magazine group ID based on the calculated hash value (ff89023facd101).

Controller 21 refers to magazine group list 43 to be stored in database 30 using the names of the account/container as keys, and obtains magazine IDs from the obtained magazine group ID (S33). For example, when magazine group list 43 shown in FIG. 5 is referred to, “MGZ01” and “MGZ04” are obtained as magazine IDs for magazine group ID “MGZ_GRP00” related to account01/container01.

Controller 21 then refers to magazine information 44 stored in database 30, and specifies storage device 50 of a reading destination of the object based on the obtained magazine IDs (S34). Specifically, controller 21 obtains storage numbers of storage device 50 of the reading destinations from magazine information 44 based on the magazine IDs.

For example, storage numbers “DA01” and “DA02” are obtained for magazine IDs “MGZ01” and “MGZ04”, respectively, with reference to magazine information 44 shown in FIG. 7.

Controller 21 requests storage node 40 related to the specified storage device to specify a magazine ID and an Etag and to read an object (S35). When controller 41 of storage node 40 receives this request, controller 41 controls storage device 50 so as to read object data from specified magazines 8 and transmit the object data to proxy node 20.

For example, proxy node 20 specifies the magazine IDs “MGZ01” and “MGZ04” for storage nodes 40 related to the two storage devices having the storage numbers “DA01” and “DA02”, respectively, and requests to read the object having the Etag (“d9f5fgjhi987dx”). Storage node 40 reads the object data having Etag (“d9f5fgjhi987dx”) according to this request so as to transmit the read object data to proxy node 20.

In the above manner, the object that is requested to be read by the user can be read (reproduced) from storage device 50.

The object data read from storage device 50 is to be stored in cache 45 of storage node 40. When storage node 40 receives the reading request from proxy node 20, storage node 40 determines whether the object data to be read is stored in cache 45.

When the object data to be read is stored in cache 45, storage node 40 reads the object data to be read from cache 45, and transmits the object data to data management device 10. On the other hand, when the object data to be read is not stored in cache 45, storage node 40 reads object data to be read from storage device 50 and transmits the read object data to data management device 10.

When the data stored in cache 45 at the reading time is not accessed for a predetermined time, this data is deleted. When the cache is used in such a manner, the processing time totally required for the reading operation can be shortened.

1-2-3. Process for Recovering Redundancy

In this exemplary embodiment, as shown in FIG, 5, one magazine group is configured so as to include a plurality of magazines. Magazines included in one magazine group are set for a magazine group so as to belong to different storage devices (rack).

For example, as shown in FIG. 5, a magazine group “MGZ_GRP00” includes two magazines “MG01” and “MG04”. The magazine “MG01” and the magazine “MG04” belong to different storage devices (DA01, DA02). Such a configuration maintains redundancy.

In data archive system 100 of this exemplary embodiment, when recording in as certain magazine belonging to the same magazine group fails but recording in another magazine succeeds, the recording request is regarded as successful. In such a case, however, data archive system 100 again performs the failed recording operation in that magazine, so that redundancy is recovered.

Specifically, when controller 21 of proxy node 20 can determine that redundancy of a certain object cannot be secured (namely, object data can be properly recorded only in one magazine in a plurality of magazines belonging to one magazine group), controller 21 copies the object data from a magazine where the object data is properly recorded to the magazine where the recording of the object data fails.

As a result, the redundancy of the object data is secured.

Specifically, when the recording; of an object that has been stored in cache 45 into storage device 50 fails, storage node 40 transmits information representing the failure of the recording to proxy node 20.

When controller 21 of proxy node 20 receives that information, controller 21 records the failure information in second data storage 22b (or first data storage 22a). The failure information includes a magazine ID representing the magazine where the recording of the object fails, a name of the object whose recording fails, and an Etag of the object.

Controller 21 refers to the failure information at predetermined time intervals (for example, intervals of 10 minutes). When the determination can be made that the recording of the object recorded in the failure information into a certain magazine fails but the recording into the other magazine succeeds, controller 21 retries the recording into the failed magazine.

That is to say, controller 21 reads the object data from the magazine where the object recording succeeds and copies the read object data to the magazine where the recording fails. As a result, a state that the data of one object is retained, in a plurality of magazines (different storage devices) can be secured, so that the redundancy can be recovered.

1-2-4. Backup of Object/Magazine Group ID Correspondence Information

Controller 21 of proxy node 20 records object/magazine group ID correspondence information 42 stored in first data storage 22a as backup in any storage device 50 (rack) at predetermined timing (for example, at every constant time).

As a result, object/magazine group ID correspondence information 42 stored in first data storage 22a is destroyed or first data storage 22a breaks down and thus object/magazine group ID correspondence information 42 cannot be read, object/magazine group ID correspondence information recorded as a backup in storage device 50 is used so that the object/magazine group ID correspondence information can be restored on first data storage 22a.

1-3. Effects

Data archive system (one example of the data recording and reproducing system) 100 according to this exemplary embodiment is a system that can record and reproduce data in and from an optical disc (one example of the recording medium).

Data archive system 100 includes storage device 50 having optical discs 9 in which data is stored, and data management device 10 that controls recording of data in storage device 50 and reproducing of data from storage device 50.

Data management device 10 includes network interface unit 25, first data storage 22a, second data storage 22b (an example of the second storage), and controller 21. Network interface unit 25 specifies an object name including a pathname and accepts a request to record or reproduce an object in or from storage device 50. Second data storage 22b stores database 30 that manages information representing recording regions on storage device for objects. Controller 21 controls the storage device according to a request.

When accepting the request to record an object, controller 21 refers to database 30 and specifies a recording region in the storage device for the object so as to store data of the object in the specified region.

Further, controller 21 stores object/magazine group ID correspondence information 42 (one example of first management information) in first data storage 22a (an example of first storage), in object/magazine group ID correspondence information 42, each Etag (one example of information for uniquely specifying each object) is related to each magazine group ID (one example of index information representing each region in each storage device 50 where each object is stored).

Data archive system 100 according to this exemplary embodiment records the index information (magazine group IDs) representing storage regions of objects in first data storage 22a, and records entity data of objects in another region. As a result, information representing the storage regions of objects can be managed by a simple structure.

Further, controller 21 may calculate information for uniquely specifying an object based on the object (the Etag).

Further, when accepting a request to reproduce an object, the controller reads index information (a magazine group ID) from object/magazine group ID correspondence info 42 based on the calculated Etag from the object, and may read data of the object from storage device 50 based on the read index information.

Storage device 50 includes a plurality of magazines that store a plurality of the optical discs, and may manage a predetermined number of magazines as a magazine group. Object/magazine group ID correspondence information 42 may be managed so that objects and magazine groups are related to each other. Database 30 may include second management information (magazine group list 43) and third management information (magazine information 44). The second management information manages paths of objects and magazine groups that are related to each other. The third management information manages magazine groups and storage devices that are related to each other.

When accepting a request to record an object (S10 in FIG. 8), controller 21 refers to the second and third management information and may specify a magazine group in which an object is to be stored (S12 to S14). Controller 21 may store object/magazine group ID correspondence information 42 in a region of first data storage 22a (S17). In object/magazine group ID correspondence information 42, values (Etags) calculated from objects and magazine group IDs for specifying magazine groups are related to each other.

Further, when accepting the request to reproduce an object (S30 in FIG. 10), controller 21 may read the first management information based on the value calculated from the object data and may specify a magazine group related to the object (S31 to S32).

Controller 21 then may refer to the second and third management information based on the specified magazine group, and may specify storage device 50 (S33 to 534) so as to read the object data from the specified storage device (S35).

The above data recording and reproducing system may be configured so as to be operable by an API (Application Program Interface) of Swift of OpenStack Object Storage.

### Second Exemplary Embodiment

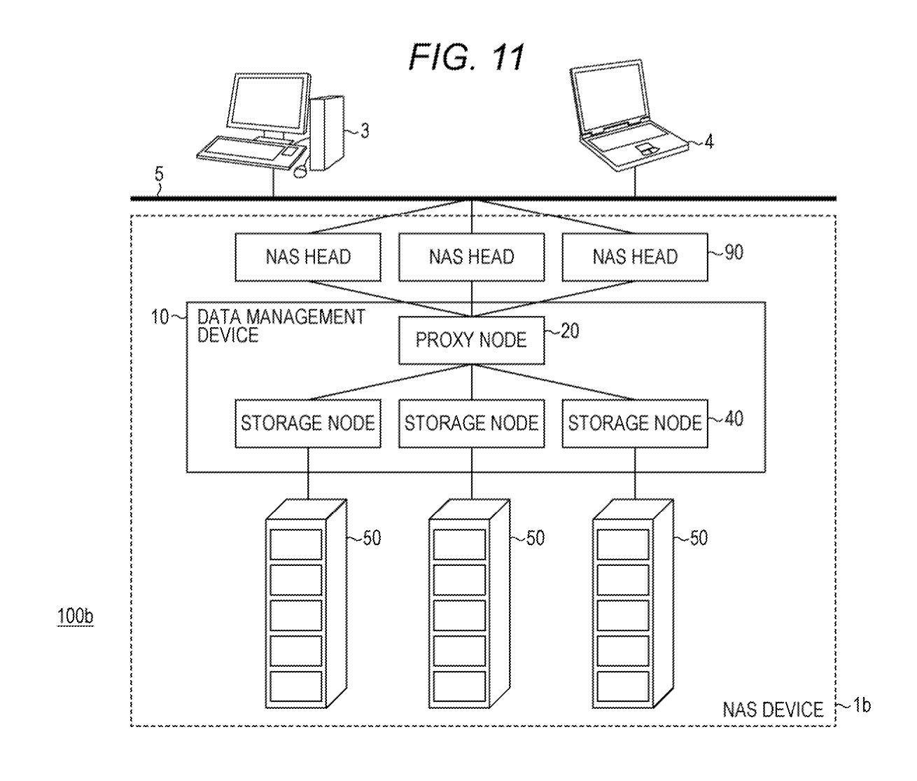

This exemplary embodiment describes a configuration example when a data archive system is formed by an NAS (Network Attached Storage) device, FIG. 11 illustrates a configuration example of the data archive system that is formed by an NAB device.

As shown in FIG. 11, in data archive system 100b of this exemplary embodiment, NAS device 1b includes NAS heads 90, data management device 10, and storage devices 50. Data management device 10 and storage devices 50 have the similar configurations described in the first exemplary embodiment, and perform the similar operations.

Data management device 10 is connected to network 5 via NAS heads 90. Each NAS head 90 is formed by an information processing device. In FIG. 11, each NAS head 90 is provided in each of different tenants. Each NAS head 90 has a function that converts an API of Windows (registered trademark) (Microsoft Corp.) into the API of the Swift.

As a result, the user can operate data archive system 100b through a viewing software (for example, Internet Explorer provided by Microsoft Corp.)

### Another Exemplary Embodiment

The first and second exemplary embodiments have been described above as the examples of the technique disclosed in this application. However, the technique in this disclosure is not limited to them, and thus can be applied also to an exemplary embodiment where modification, replacement, addition and omission are suitably made. Further, the components described in the exemplary embodiments are combined so as to be capable of providing a new exemplary embodiment. Therefore, another exemplary embodiment is illustrated below.

In the above exemplary embodiments, storage node 40 is provided to each of a plurality of storage devices 50, but one storage node may control the plurality of storage devices 50.

The above exemplary embodiments describes the examples where proxy node 20 and storage nodes 40 are formed by individual server devices, but the functions of proxy node 20 and storage nodes 40 can be realized also by one server device.

In the above exemplary embodiments, object/magazine group correspondence information 42 and database 30 are stored in first data storage 22a and second data storage 22b, respectively, but these pieces of information may be stored in one recording device.

In the above exemplary embodiments, database 30 that manages magazine, group list 43 and magazine information 44 may be provided inside proxy node 20, but may be provided to an outside of proxy node 20.

In the above exemplary embodiments, hash values are calculated, as values that uniquely represent names of account/container/object. Further, a hash value (Etag) is obtained as a value that uniquely represents an object The value that can uniquely specify the name of account/container/object or an object are not limited to the hash value, and thus another value may be calculated.

Further, a hard disk in which object/magazine group ID correspondence information 42 is recorded may be specified by the Ring function of the Swift based on the name of account/container/object.

According to the original function of the Swift, entity data of an object is recorded in a region (a hard disk) to be determined by the Ring based on the name of account/container/objects.

On the contrary, the Ring is set so that the hard disk where object/magazine group ID correspondence information 42 is recorded is specified by the Ring function as described above, so that an idea of the present disclosure can be applied while the API of the Swift is being used.

In the above exemplary embodiment, object storage device 1 can perform the operation through the API of the Swift, but the idea of the present disclosure can be applied also to a data recording/reproducing apparatus that cannot perform the operation through the API of the Swift.

That is to say, when the data recording device has a function for calculating a value uniquely representing an object to be recorded (for example, a hash value) and a function for recording any information in a recording region related to the calculated value, the idea of the present disclosure can be applied to the device.

The exemplary embodiments have been described above as the example of the technique in the present disclosure. For this reason, the accompanying drawings and the detailed description are provided.

Therefore, the components described in the accompanying drawings and the detailed description include not only essential components but also unessential components in order to illustrate the above-described technique. For this reason, even if these unessential components are described in the accompanying drawings and the detailed description, the unessential components should not be immediately regarded as essential.

Further, since the above exemplary embodiments illustrate the technique in the present disclosure, various modifications, substitutions, additions and omissions can be performed within the scope of claims and equivalent scope of claims.

What is claimed is:

1. A data recording and reproducing system comprising:
a storage device having a recording medium that stores data and
a data management device that controls recording of data in the storage device and reproducing of data from the storage device, wherein
the data management device includes
an acceptor that specifies an object name including a pathname and accepts a request to record or reproduce an object in or from the storage device,
a first storage,
a second storage that stores a database for managing information representing a recording region on the storage device fir an object, and
a controller that controls the storage device according to the request, and wherein
when the acceptor accepts a request to record an object, the controller refers to the database so as to specify a recording region in the storage device for the object and store data of the object in the specified region, and stores first management information in the first storage, the first management information being configured so that information for uniquely specifying the object is related to index information representing the region in the storage device that stores the object.

2. The data recording and reproducing system according to claim 1, wherein the controller calculates the information for uniquely specifying the object, based on the object.

3. The data recording and reproducing system according to claim 2, wherein when the acceptor accepts is request to reproduce an object, the controller reads the index information from the first management information based on a value calculated based on the object, and reads data of the object from the storage device based on the read index information.

4. The data recording and reproducing system according to claim 1, wherein the storage device includes a plurality of magazines that store a plurality of recording media and manages a predetermined number of magazines as a magazine group,
the first management information manages an object and the magazine group so that the object and the magazine group are related to each other,
the database includes second management information and third management information, the second management information relating a path to a magazine group of an object, the third management information relating the magazine group to the storage device, and wherein
when the acceptor accepts a request to record an object, the controller refers to the second management information and the third management information so as to specify a magazine group where the object is to be stored, and relates a value calculated based on the object to a magazine group ID for specifying the magazine group so as to store the value and the magazine group ID as the first management information in the first storage.

5. The data recording and reproducing system according to claim 4, wherein when the acceptor accepts a request to reproduce an object, the controller reads the first management information based on the value calculated from the object so as to specify a magazine group related to the object, and refers to the second management information and the third management information based on the specified magazine group so as to specify a storage device and to read data of the object from the specified storage device.

6. The data recording and reproducing system according to claim 4, wherein the magazine group includes a plurality of magazines allocated, to different storage devices.

7. The data recording and reproducing system according to claim 4, wherein when recording of an object in a certain magazine forming the magazine group fails, the controller again executes the recording of the object in the magazine where the recording has failed, using data of the object recorded in the magazine where the recording has succeeded.

8. The data recording and reproducing system according to claim 1, wherein the controller stores, in the recording medium, the first management information stored in the first storage at specified timing.

9. The data recording and reproducing system according to claim 1, configured to be operable by an API (Application Programming Interface) of a Swift of an OpenStack Object Storage.

10. The data recording and reproducing system according to claim 1, wherein the recording medium is a write-once type optical disc.
